(19) United States
(12) Patent Application Publication
(10) Pub. No.: US 2006/0171452 A1
(43) Pub. Date: Aug. 3, 2006

(54) Method and apparatus for dual mode digital video recording

(76) Inventor: Glenn C. Waehner, Fresno, CA (US)

Correspondence Address: Paul T. Kashimba, Esq.;Gunster, Yoakley & Stewart, P.A., Suite 1400, 500 East Broward Boulevard, Fort Lauderdale, FL, 33394, US

(21) Appl. No.: 11/047,495

(22) Filed: Jan. 31, 2005

(51) Int. Cl. H04N 11/04; H04N 7/18; H04N 9/47; H04N 11/02; H04N 7/12; H04B 1/66

(52) U.S. Cl. 375/240.01; 348/143

(57) ABSTRACT

A method and apparatus for recording video data in a surveillance system comprising receiving video data from a surveillance camera, recording the received video data at a first rate, and recording the received video data at a second rate with the second rate being slower than the first rate.

### CROSS-REFERENCE TO RELATED APPLICATION

N/A

### STATEMENT REGARDING FEDERALLY SPONSORED RESEARCH OR DEVELOPMENT

N/A

### BACKGROUND OF THE INVENTION

This invention relates to video surveillance and, in particular, to an apparatus and method of storing video data in a video surveillance system.

Storing video data gathered by video surveillance systems has been a challenge because of the large amount of data involved. In many instances, the video data must be archived for thirty days or more. The storage problem is compounded by the number of channels in a multi-channel system. Moreover, the stored video data must provide good quality images to allow accurate identification of people and things captured by the video cameras. The present solution to this problem is to install more hard drives to provide more storage capacity in the recorder or to archive the system data in external storage before the internal system storage becomes full. Adding additional hard drives to the system is expensive, and the alternative of external archiving is labor intensive and can be prone to error or mishandling. To avoid the costs of additional hard drives and archiving, as well as the possible data loss associated with the archiving, prior art users have undergone complex set-up processes that requires the user to guess which cameras in the surveillance system are most likely to observe an event and set those individual camera recording rates higher. Correspondingly, the prior art user must slow the recording rate of all other lower priority cameras to achieve the total recording time needed. Obviously, this is a lengthy and error prone procedure and a compromise that most surveillance system users would prefer not to make.

Accordingly, there has been a long felt need in the art for a system and method that provides the video data needed for quality images for identification purposes, but requires nominal storage capacity and eliminates the need for constant external archiving.

### SUMMARY OF THE INVENTION

In accordance with the present invention there is provided a method of recording video data in a surveillance system comprising the steps of receiving video data from a surveillance camera, recording the received video data at a first rate, and recording the received video data at a second rate with the second rate being slower than the first rate. This concept takes advantage of the fact that most people know within a few hours that a security event has taken place, and would desire to have the best possible images available for recall and review. Should the event go un-noticed for a few days, the system will still have a subset of the original images in the longer-term memory. The step of recording the received video data at a first rate can comprise the steps of compressing the received video data from a plurality of surveillance cameras and storing the compressed video data from the plurality of surveillance cameras. The step of recording the received video data at a second rate can comprise the steps of sampling or taking a subset of the video data from the compressed video data and storing the sampled video data or sampling the received video data from the plurality of video cameras, compressing the sampled video data, and storing the compressed sampled video data. In an alternate embodiment the method can further comprise the step of digitizing the video data received from said plurality of surveillance cameras.

The present invention also provides an apparatus for recording video data in a surveillance system comprising a plurality of inputs for receiving video data, a first memory for storing video data, a second memory for storing video data, and a processor connected to the plurality of inputs and the first and second memories. The processor compresses the video data received on the plurality of inputs, stores the compressed video data in the first memory at a first rate, samples and forms a subset of the compressed video data, and stores the compressed sampled video data in the second memory. The video data in the first and second memories can be overwritten when each memory becomes full. The second memory will take longer to fill up as it is being written slower with a subset or sample of the data being written in the first memory. If an event is detected as abnormal or critical, it can be marked to prevent the automatic overwriting of data. It is also evident that one memory partitioned into two storage areas, can be used instead of two separate memories. The compressed video data can be stored in the first memory at the same rate that video data is received at the plurality of inputs or at the maximum rate allowed by the capacity of the digital video recorder as configured, whereas the compressed sampled video data is stored at a lesser rate. In an alternative embodiment, the apparatus further comprises a plurality of analog-to-digital converters connected between the plurality of inputs and the processor to convert analog video data to digital video data.

Still further, the present invention provides a video surveillance system comprising a network, a plurality of video cameras connected to the network, and a digital video recorder connected to the network. The digital video recorder has a plurality of inputs to receive video data from the plurality of video cameras, a first memory for storing video data; a second memory for storing video data, and a processor connected to the plurality of inputs and the first and second memories. The digital video recorder compresses video data received on the plurality of inputs and stores the compressed video data in the first memory at a first rate. In addition, the digital video recorder samples the compressed video data, and stores the compressed sampled video data in the second memory.

The present invention provides two separate and different recording modes in the digital video recorder. One mode provides high quality, maximum or high update rate video for a short period of time, for example, a day, for all cameras. This provides the user with the maximum amount of information to review recent events, i.e., within the predefined period of time before which data will be overwritten, if not marked as important. The present invention provides ease of use over prior art systems because the user does not need to try to determine which cameras may be more likely to be positioned in an area where an event will occur and then set priorities in the setup of the digital video recorder so that the selected priority cameras will be recorded at preferred speeds and resolution. The system of the present invention allows all cameras to be recorded at high speed, i.e., the rate at which the video data is received or which the system can process. It allows the recording of all or most of the frames received for each camera at the full frames per second rate received by the video recorder or within its processing capability.

The second mode provides time lapse recording where the various cameras are recorded at a slower rate and, if desired, at a lower resolution but for a much longer period of time to allow the user to have record of an event kept for a month or more but without full details as provided by the first mode. Users of video surveillance systems usually know within minutes and almost certainly within a few hours that they have had an event occur that warrants reviewing in detail or saving of the recorded video data. The present invention also provides time lapse recording of video data with lower resolution, if desired, for longer term archival storage and for events that have not been detected and would otherwise be lost because of the overwriting of the data required by the constant large amount of video data being recorded by the first mode at the higher rate and higher resolution. In addition, when security personnel respond to an alarm event, they will always miss the beginning of the occurrence. In the present invention, the short-term storage always has the desired video data for the alarm event.

In addition to recording video, the digital recorder to also accept audio signals and point of sale data associated with specific cameras. In previous embodiments these signals have been superimposed on top of the video images. This has the disadvantage that if the video was recorded at a slow speed to maximize image storage time, the fidelity of the audio is compromised or may not be recorded at all, and the update rate of the POS information is reduced to less than needed rates. The audio can be allocated to a third recording channel and the POS to a fourth channel, each optimized for their specific application and independent of the video recording rates. These additional recording paths would be set to overwrite at the same time as the sampled channel. Also, these additional channels can be locked and prevented from overwriting along with the critical video data. The multiple recording paths can use different memories, or one memory partitioned into multiple sections.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1 is a block diagram of a video surveillance system utilizing the present invention.

FIG. 2 is a block diagram of a digital video recorder according to the present invention.

FIG. 3 is a flow chart of one embodiment of the present invention.

FIG. 4 is a block diagram of one embodiment of the present invention.

### DETAILED DESCRIPTION OF THE INVENTION

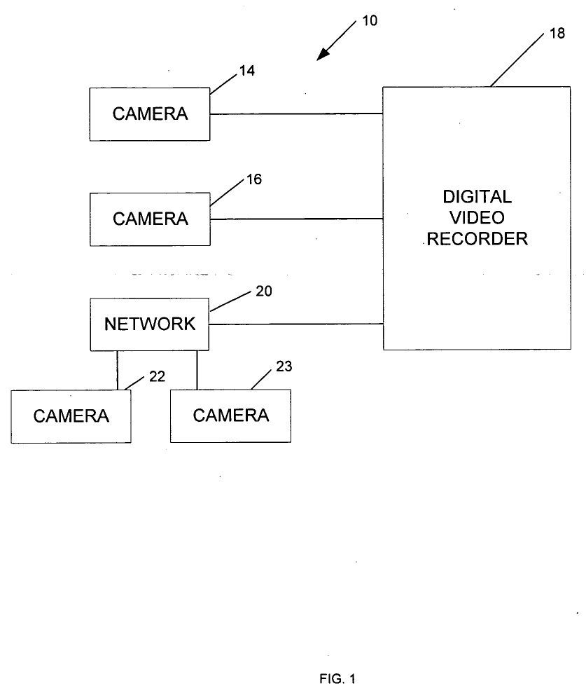

Referring to FIG. 1, a video surveillance system 10 has plurality of video cameras 14, and 16, which can be analog or digital cameras that provide real-time or near real-time video data. Cameras 14 and 16 are connected to digital video recorder 18 by, for example, individual cable, for recording the video data from the respective cameras. A network 20, which can be a closed network, local area network, or wide area network, such as the Internet is connected to digital video recorder 18. Cameras 22 and 23 can provide compressed network compatible data streams, such as JPEG or MPEG type compressed data streams.

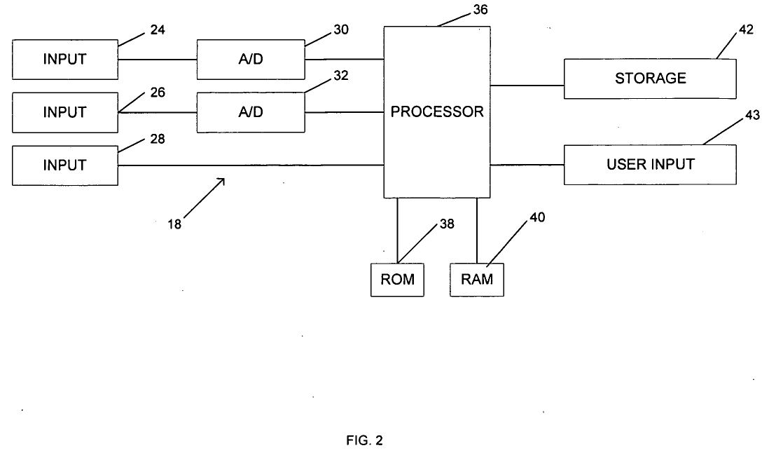

As shown in FIG. 2, digital video recorder 20 has inputs 24, 26, and 28 for receiving the video data; digital video recorder 18 may have any number of inputs, for example, sixteen. Inputs 24 and 26 are connected to analog-to-digital converters 30 and 32 respectively to digitize analog signals received from analog type cameras. Input 28 can receive digital video data from a hard-wired digital type camera or compressed, digitized video data from cameras connected to a network, such as network 20 in FIG. 1. Analog-to-digital converters 30 and 32 and input 28 are connected to processor 36. Analog-to-digital converters 30 and 32 can be eliminated if suitable analog-to-digital converters are connected between the analog camera and the selected input of digital video recorder 18. For example, analog-to-digital converters 30 and 32 can be located as a separate unit outside of digital video recorder 18, or they can be located with the respective analog cameras. ROM 38, RAM 40, storage 42 and user input 43 are also connected to processor 36. The programs and algorithms for implementing the present invention can be stored in ROM 38, or storage 42, which can be, for example, one or more hard disc drives. User input 43 can be, for example, control buttons on digital video recorder 18 for setting up digital video recorder 18, or user input 43 can be, for example, a workstation such as a control point in surveillance system 10, a personal computer and monitor, or a user logged into surveillance system 10 by means of a laptop computer providing setup information over a network to digital video recorder 18. The setup input provided to processor 36 can be, for example the record rate in frames per second, recording resolution for each camera, how long that digital video recorder can record at maximum speed and how many channels of data will be sampled, compressed and stored as explained hereinafter in detail.

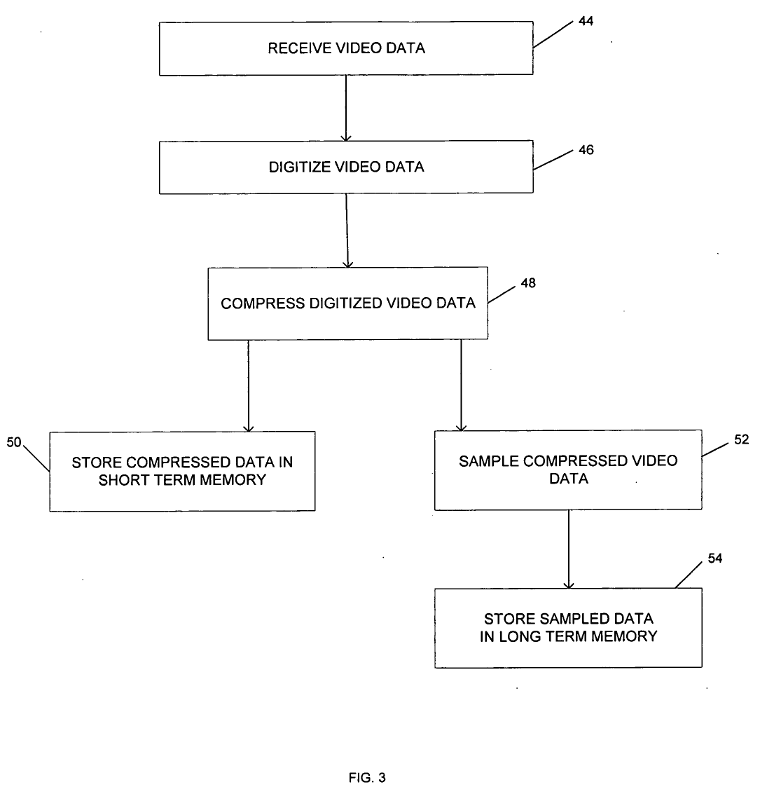

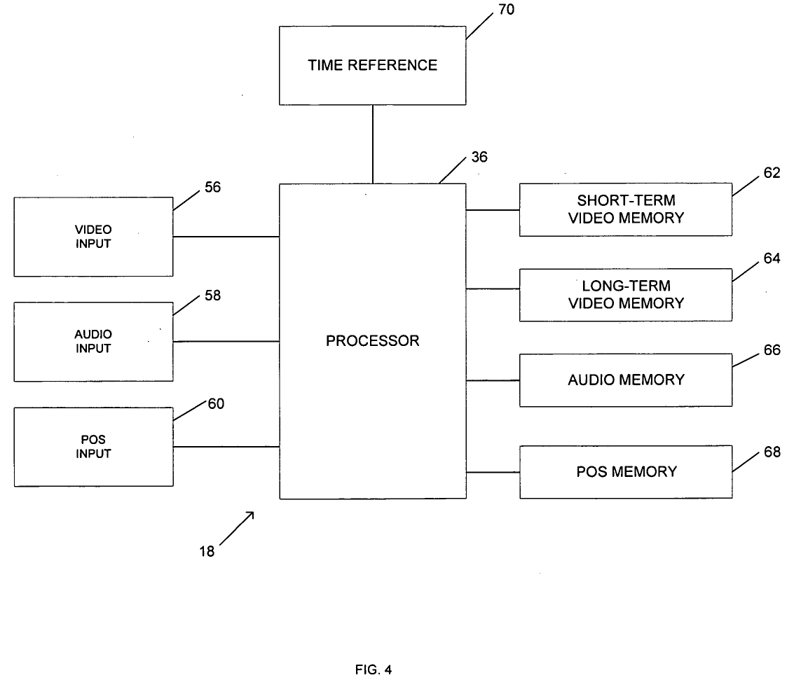

FIG. 3 illustrates a flowchart for implementing one embodiment of the present invention. Step 44 indicates that video data is received from an analog camera, such as cameras 14, and 16 in FIG. 1. At step 46 the video data from a respective camera is digitized by an analog-to-digital converter, such as analog-to-digital converters 30 and 32. If the camera is a digital camera, the respective analog-to-digital converter can be eliminated or bypassed as discussed above in relation to FIG. 2. At step 48, the digital signal is then compressed by processor 36 utilizing software and/or algorithms stored in ROM 38 or storage 42 as is known in the art to reduce the amount of storage required to record the video captured by cameras 14 and 16. The video data can be compressed using, for example, JPEG or other non-frame related compression or MPEG or other frame related compression. The digitized, compressed video is stored in short-term storage in storage 42 of digital video recorder 18 at step 50 with a time reference, which is discussed in detail with reference to FIG. 4. The short-term storage may be, for example, a designated area or partition of a hard disc drive, designated one of a plurality of drives, optical drive, or solid state memory in digital video recorder 18, or other suitable storage. The digitized video data from step 48 is sampled at step 52 for each camera connected to digital video recorder 18 so that for each camera only one out of every predetermined number of sequential images or frames is provided to step 54. In step 54 the multiplexed video data from step 52 is stored in long-term storage, which can be, for example, a designated area or partition of a hard disc drive, designated one of a plurality of drives, optical drive, or solid state memory in digital video recorder 18, or other suitable storage. This sampling or stream decimation of each of the data streams received by digital video recorder 18 is performed at a predetermined rate selected by a user at setup of digital video recorder 18. This reduces the number of images per camera per second, but allows recording of multiple cameras, typically sixteen, for a long period of time.

The present invention provides a first mode in which the video data received from each video camera connected to digital video recorder 18 is stored in short-term storage at the same rate that it is received or at the maximum capacity of digital video recorder 18 so that a user can view high quality, full rate videos. Depending upon the image rate from the cameras, the number of cameras connected to digital video recorder 18 and the capacity of video recorder 18 to record data, digital video recorder 18 records the data either at the rate that it is received by video received by digital video recorder 18 or its maximum capacity to either capture the video data in its entirety or as much as possible allowed by the current configuration. These high quality, full rate videos consume a significant amount of digital storage that will fill a hard disc drive in a short period of time, such as a few days. The video data is stored and then overwritten in normal ring buffer fashion. The second mode of the present invention provides time lapse type recording where the various cameras are recorded at a slower rate and if desired at a lower resolution but for a much longer period of time to allow the user to have record of an event kept for a month or more but without full details as provided by the first mode. This long-term storage or memory can also overwrite when full if desired, but this will occur in a longer period of time than the short-term memory in the first mode. The embodiment of the invention shown in FIG. 3 illustrates the steps in handling an analog camera input that is then compressed using JPEG type compression. If the input received is from a digital camera or analog camera with a respective analog-to-digital converter, then step 46 can be eliminated. Similarly, if the received input is from a networked camera, then step 46 cab be eliminated. In the case of a networked camera where the digitized data has been compressed with an MPEG type compression, then the MPEG stream would have to be decoded in the second mode, the images sampled at the predetermined rate and then compressed for long-term storage.

FIG. 4 shows one embodiment of the present invention in which digital video recorder 18 has one or more video inputs 56 which can be a video input as illustrated by inputs 24, 26, or 28 for receiving video data. Digital video recorder 18 also has one or more audio inputs 58 and point of sale inputs 60 for respectively receiving audio data and point of sale data associated with video data received by video input 56. Video data received by video input 56 is provided to processor 36 for processing and storage in short-term video memory 62 and long-term video memory 64 as discussed in relation to FIGS. 1-3. Audio input received by audio input 58 is provided to processor 36 for processing and storage in audio memory 66. The audio data may be recorded directly in audio memory 66 or compressed by processor 36 and then stored in audio memory 66. Point of sale data, such as retail transaction information, received by point of sale input 60 is provided to processor 36 for processing and storage in point of sale memory 68. The point of sale data may be recorded directly in point of sale memory 68 or compressed by processor 36 and then stored in point of sale memory 68. Audio memory 66 and point of sale memory 68 are separate and independent from short-term video memory 62 and long-term video memory 64; however, they may be part of storage 42 in FIG. 2. The rates at which the data in audio memory 66 and point of sale memory 68 are independent of the rates at which video data is stored in short-term video memory 62 and long-term video memory 64. Time reference 70 provides time reference signals to processor 36 which associates these time reference signals with each of the stored data streams, so that the data stored in short-term video memory 62, long-term video memory 64, audio memory 66, and point of sale memory 68 have appropriate time reference signals so that independent stored data can be appropriately referenced and synchronized for play back upon request by a user.

In addition, if an event, such as an alarm, occurs in surveillance system 10, digital video recorder 18 can be notified via network 20 or other suitable means as is known in the art. Digital video recorder can then mark the pertinent video data in short-term video memory 62 to protect the data recorded during the event to be protected so that it is not overwritten. For example, an appropriate entry or flag can be provided in the descriptor field of the pertinent data. Alternatively, the video data could be written to a designated portion of short-term video memory 62 or another independent memory where it is never overwritten until released. Similarly, the audio data and point of sale data can also be protected from overwriting.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. A method of recording video data in a surveillance system comprising the steps of: receiving video data from a surveillance camera; recording the received video data at a first rate; and recording the received video data at a second rate, said second rate being slower than said first rate.

2. A method as recited in claim 1 wherein said receiving step comprises receiving video data from a plurality of surveillance cameras and said step of recording the received video data at a first rate comprises the steps of compressing the received video data from said plurality of surveillance cameras and storing the compressed video data from said plurality of surveillance cameras.

3. A method as recited in claim 2 wherein said step of recording the received video data at a second rate comprises the steps of sampling the compressed video data from said plurality of surveillance cameras and storing the sampled video data.

4. A method as recited in claim 2 wherein said step of recording the received video data at a second rate comprises the steps of sampling the video data received from said plurality of surveillance cameras, compressing the sampled video data and storing the compressed sampled video data.

5. A method as recited in claim 1 wherein said step of recording video data at a first rate comprises recording said video data from said plurality of video cameras continuously.

6. A method as recited in claim 5 wherein said step of recording video data at a second rate comprises recording said video data from said plurality of video cameras periodically.

7. A method as recited in claim 1 wherein said step of recording the received video data at a first rate comprises recording the received video data at the same rate that the video data is received and said step of recording the received video data at a second rate comprises recording the received video data at a rate that is less than the rate that the video data is received.

8. A method as recited in claim 1 wherein said step of recording the received video data at a first rate comprises overwriting video data that has been stored after a period of time.

9. A method as recited in claim 3 wherein said step of recording video data at a first rate comprises recording said video data from said plurality of video cameras continuously.

10. A method as recited in claim 3 wherein said step of recording the received video data at a first rate comprises recording the received video data from said plurality of video cameras at same rates that the video data is received from said plurality of video cameras.

11. A method as recited in claim 3 further comprising the step of digitizing the video data received from said plurality of surveillance cameras and wherein said step of compressing the video data received from said plurality of surveillance cameras comprises compressing the digitized video data from said plurality of surveillance cameras and said step of sampling the video data received from said plurality of surveillance cameras comprises sampling the digitized video data from said plurality of surveillance cameras.

12. A method as recited in claim 1 further comprising the steps of receiving an indication of an event and preventing the video data recorded at said first rate during said event from being overwritten.

13. A method as recited in claim 1 further comprising the steps of receiving audio data associated with said received video data and recording the received audio data independently of said received video data.

14. A method as recited in claim 1 further comprising the steps of receiving point of sale data associated with said received video data and recording the received point of sale data independently of said received video data.

15. An apparatus for recording video data in a surveillance system comprising: a plurality of inputs for receiving video data; a first memory for storing video data; a second memory for storing video data; a processor connected to said plurality of inputs and said first and second memories for compressing video data received on said plurality of inputs, storing the compressed video data in said first memory at a first rate, sampling the compressed video data and storing the sampled video data in said second memory.

16. An apparatus as recited in claim 15 wherein the video data in said first memory is overwritten when said first memory is full.

17. An apparatus as recited in claim 15 wherein the compressed video data is stored in said first memory at the same rate that video data is received at said plurality of inputs.

18. An apparatus as recited in claim 17 wherein the sampled video data is stored at a rate that is less than the rate that video data is received at said plurality of inputs.

19. An apparatus as recited in claim 15 further comprising a plurality of analog-to-digital converters connected between said plurality of inputs and said processor to convert analog video data to digital video data.

20. An apparatus as recited in claim 15 further comprising an input for receiving audio data associated with video data received on said plurality of inputs for receiving video data, a third memory, and wherein said processor stores audio data received by said input for receiving audio data in said third memory independently of the video data received on said plurality of inputs for receiving video data.

21. An apparatus as recited in claim 15 further comprising an input for receiving point of sale data associated with video data received on said plurality of inputs for receiving video data, a fourth memory, and wherein said processor stores point of sale data received by said input for receiving point of sale data in said fourth memory independently of the video data received on said plurality of inputs for receiving video data.

22. An apparatus as recited in claim 20 further comprising a time reference generator for providing a time reference to said processor and wherein said processor associates a time reference with video data stored in said first and second memories and audio data stored in said third memory so that video data and audio data can be correlated.

23. An apparatus as recited in claim 21 further comprising a time reference generator for providing a time reference to said processor and wherein said processor associates a time reference with video data stored in said first and second memories and point of sale data stored in said fourth memory so that video data and point of sale data can be correlated.

24. An apparatus as recited in claim 15 further comprising an input for receiving an indication of an event and wherein said processor prevents video data stored in said first memory during said event from being overwritten.

25. An apparatus for recording video data in a surveillance system comprising: a plurality of inputs for receiving video data; a first memory for storing video data; a second memory for storing video data; a processor connected to said plurality of inputs and said first and second memories for compressing video data received on said plurality of inputs, storing the compressed video data in said first memory at a first rate, sampling the video data received at said plurality of inputs at a second rate that is less than said first rate, compressing the sampled video data, and storing the compressed sampled video data in said second memory.

26. A video surveillance system comprising: a network; a plurality of video cameras connected to said network; a digital video recorder connected to said network, said digital video recorder having a plurality of inputs to receive video data from said plurality of video cameras, a first memory for storing video data; a second memory for storing video data, a processor connected to said plurality of inputs and said first and second memories for compressing video data received on said plurality of inputs, storing the compressed video data in said first memory at a first rate, sampling the compressed video data and storing the compressed sampled video data in said second memory.

27. A video surveillance system as recited in claim 26 wherein the video data in said first memory of said digital video recorder is overwritten when said first memory is full.

28. A video surveillance system as recited in claim 26 wherein the compressed video data is stored in said first memory of said digital video recorder at the same rate that video data is received at said plurality of inputs of said digital video recorder.

29. A video surveillance system as recited in claim 28 wherein the compressed sampled video data is stored at a rate that is less than the rate that video data is received at said plurality of inputs of said digital video recorder.

30. An video surveillance as recited in claim 26 wherein said plurality of video cameras are analog cameras and said digital video recorder further comprises a plurality of analog-to-digital converters connected between said plurality of inputs and said processor to convert analog video data to digital video data.

31. A video surveillance system comprising: a network; a plurality of video cameras connected to said network; a digital video recorder connected to said network, said digital video recorder having a plurality of inputs to receive video data from said plurality of video cameras, a first memory for storing video data; a second memory for storing video data, a processor connected to said plurality of inputs and said first and second memories for compressing video data received on said plurality of inputs, storing the compressed video data in said first memory at a first rate, sampling the video data received at said plurality of inputs at a second rate that is less than said first rate, compressing the sampled video data, and storing the compressed sampled video data in said second memory.
